(19) United States
(12) Patent Application Publication
(10) Pub. No.: US 2010/0246679 A1
(43) Pub. Date: Sep. 30, 2010

(54) VIDEO DECODING IN A SYMMETRIC MULTIPROCESSOR SYSTEM

(75) Inventors: Sumit DEY, Bangalore (IN); Tushar Kanti ADHIKARY, Bangalore (IN); Srikanth REDDY, Bangalore (IN); Srinivasu GUDIVADA, Bangalore (IN)

Correspondence Address: Workman Nydegger;1000 Eagle Gate Tower, 60 East South Temple, Salt Lake City, UT, 84111, US

(73) Assignee: ARICENT INC., George Town (KY)

(21) Appl. No.: 12/410,220

(22) Filed: Mar. 24, 2009

(51) Int. Cl. H04N 11/02; G06F 15/76; G06F 9/06

(52) U.S. Cl. 375/240.16; 712/30; 712/E09.003; 375/E07.001

(57) ABSTRACT

Systems and methods for decoding of compressed video enable the storing of compressed video data in a memory shared by a group of symmetric multiple processors. The video includes a plurality of frames and each of the plurality of frames has one or more slices. Such one or more slices are assigned, by a main processor, of the group of symmetric multiple processors to the group of multiple processors. The one or more assigned slices are partially decoded by the one or more of the group of multiple processors and the partially decoded one or more slices are stored in the memory. Subsequently, each of the plurality of frames having at least one partially decoded slice is assigned to one or more of the group of multiple processors. In a successive progression, the group of multiple processors in combination fully decodes each of the plurality of frames.

### FIELD OF THE INVENTION

This invention relates to decoding of digital images, and more particularly, to a method and system for decoding of compressed images in a symmetric multiprocessor system.

### BACKGROUND OF THE INVENTION

With advancements in digital technology, various modern video applications such as, high definition video, are played on handheld devices. It is observed that significant amount of power is required to play high definition video, since, typically, processors need significantly high frequency (number of cycles per second) to decode such highly complex streams.

To address this drawback, the playback of such streams is designed using symmetric multiprocessor architecture (SMPA), which has the capability of reducing the power by 4 times, for every doubling of the number of chips used (given that the power consumed is proportional to the square of the frequency of a chipset). While SMPA has recently become common in modern high-end PCs, the corresponding switch has not been so visible in high-end handheld devices. Yet, there are certain current technologies that make a typical high-complexity application like video decoding possible on handheld devices using SMPA.

For instance, existing systems and methods for decoding compressed video explain reading a stream of compressed video into memory (video typically including multiple pictures with each picture constituting of independent elements, which are also referred to as slices). Further, decoding of the video stream can be speeded up by parallel decoding of these elements among multiple processors in a single system sharing memory.

Still other techniques describe decoding a hierarchically coded digital video bitstream that can process a high resolution television picture in real time. The technique discloses a number of individual decoder modules, connected in parallel, each having less real time processing power than is necessary, but which when combined, have at least the necessary processing power needed to process the bitstream in real time.

Still further techniques disclose scalability of multimedia applications and provide guidelines for better utilization of multiprocessor architectures and the manner in which reduction in frequency reduces power requirements by a cubic factor.

However, there are certain drawbacks associated with current technologies. For instance, the current techniques do not address cases where slices in a picture need to be deblocked for obtaining better quality pictures (as in Mpeg4 Advanced Video Coding or AVC). For this reason, these technologies will not be able to decode such streams (encoded with AVC) with maximum efficiency since they are designed to cater to the previous video coding standards where in-loop deblocking was not considered. Further, the current technologies do not address efficiently a situation where a picture might consist of a single slice. Thus, in both such situations, the current technologies will not be able to perform decoding with maximum efficiency. Consequently, more power shall be consumed and decoding will not occur with maximum power saving. Besides, load sharing for the decoding process in current technologies is also dependent on the way a picture is divided into separate slices during encoding process. Thus, the load sharing is dependent on the content and hence not predictable.

Further, modern video coding standards like AVC puts in certain restrictions in the way deblocking needs to be done. For example, the AVC standard provides for deblocking once the entire picture has been reconstructed. This restricts usage of the current technologies for parallelism, which will reduce performance. Besides, some of the current technologies when applied on modern video coding standards may result in higher power requirements.

Hence, it is desirable to provide a solution on a multiprocessor architecture that provides a simple scalable and power-saving solution for decoding video, particularly, coded with advanced video coding standards.

### SUMMARY OF THE INVENTION

Embodiments of the present invention are directed to systems and methods for decoding compressed video data. In particular, embodiments of the invention enable decoding of compressed video data effectively in a symmetric multiple processor architecture.

According to an implementation, the method includes storing the compressed video data in a memory shared by a group of symmetric multiple processors. The video includes a plurality of frames and each of the plurality of frames has one or more slices. Such one or more slices are assigned, by a main processor, of the group of symmetric multiple processors to one or more of the group of multiple processors. The one or more assigned slices are partially decoded by the group of multiple processors and the partially decoded one or more slices are stored in the memory. Subsequently, each of the plurality of frames having at least one partially decoded slice is assigned to one or more of the group of multiple processors. In a successive progression, the group of multiple processors in combination fully decodes each of the plurality of frames.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 schematically illustrates an example of a system that may implement features of the present invention;

FIG. 2 schematically illustrates an exemplary exploded view of symmetric multiprocessors of FIG. 1 in further detail;

FIG. 3 further depicts an exemplary exploded view of the symmetric multiprocessors of FIG. 2;

FIG. 4 shows a process that illustrates a method for decoding compressed video according to an implementation;

FIG. 5 shows a diagram illustrating delay procedure employed by the main processor in the processing of macroblocks;

FIG. 6 illustrates a graph of the firing sequence for each of the symmetric multiprocessors by the main processor.

### DETAILED DESCRIPTION OF THE INVENTION

Typically, playback of complex video applications such as high definition video etc. involves consumption of significant amount of power (it will be understood by a person of skill in the art that the power consumed is proportional to square of frequency of chipset). This is so, as processors need significantly high frequency to decode such complex streams. On the other hand, symmetric multiple processor architecture, typically, has the capability of reducing power by 4 times for every doubling of the number of chips used. As such, designing of such playback of complex streams using symmetric multiple processor architecture is beneficial. In particular, video playback on handheld devices with symmetric multiprocessor architecture advantageously enables to achieve the dual benefits of increase in battery life of the handheld device and to provide a simple scalable solution.

Existing methods and systems do not cater to the enhanced complexity of design of current encoding standards, for example, Mpeg4 Part 10: Advanced Video Coding (AVC). It will be understood that Mpeg4 Part 10: AVC consists of a video coding layer (VCL) which in turn consists of multiple access units. These units are referred to as the network abstraction layer (NAL) units. Each NAL unit consists of a NAL header followed by payload and may be a VCL NAL or a non-VCL NAL. Each NAL unit may in turn be carried over a single real-time transport protocol (RTP) packet or over multiple RTP packets. Typically, each NAL unit is independently decodable. NAL units are defined for explaining transport over the network.

Further, the existing compression and decompression methods pertaining to AVC typically involve an encoder consisting essentially the steps of motion estimation/intra prediction, transform, quantization and variable length encoding (besides also embodying the steps of motion compensation, inverse quantization, inverse transform and reconstruction). A decoder primarily consists of variable length decoding (also referred to as parsing of encoded data), motion compensation, inverse quantization, inverse transform and reconstruction. With advancements in efficient handheld, mobile devices, wireless and wire-line network systems, real time encoding and decoding have emerged as a challenging prospect. Particularly, decoding of video coded with AVC with maximum efficiency in real time scenarios poses a challenge.

Disclosed systems and methods address the problem of maximum efficiency. To accomplish this, in contrast to the existing methods and systems, the present invention proposes an approach for decoding compressed video on a multiprocessor system catering to the advances in coding technology, thereby, circumventing the aforementioned drawback. In addition, the proposed approach caters to the power as well as scalability requirements. This is achieved by bringing in a factor of load-sharing among the multiple processors which in turn enhances the scalability of the design. It is to be noted that though the description uses technical jargon specific to standards specified by international telecommunication union (ITU) and international organization for standardization (ISO), the proposed approach is not limited to such standards and can be applied to any video sequence coded with advanced video coding technology.

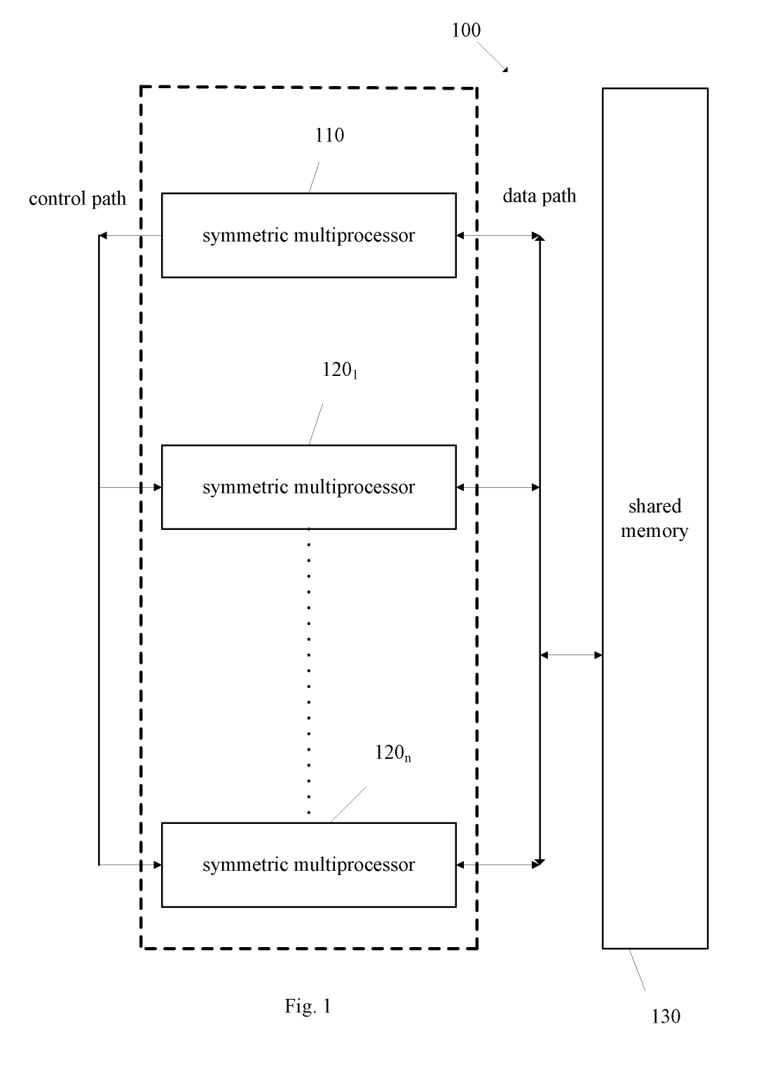

FIG. 1 schematically illustrates an example of a system 100 that may implement features of the present invention. In an implementation, system 100 is a symmetric multiple processor architecture. As shown, the symmetric multiple processor architecture constitutes multiple identical processors 110, 120₁ to 120ₙ accessing a shared memory 130. It may be appreciated that the architecture also constitutes other components such as a single input output system (not shown), a single operating system, etc. (not shown). It may be further appreciated that performance of each of the multiple processors is equal and also possess equal shared memory access capability.

In particular, the multiple symmetric/identical processors 110, 120₁ to 120ₙ consists its own internal memories and/or caches ( not shown) as well as a large pool of shared memory 130. The data paths are bidirectional between each of the processors 110, 120₁ to 120ₙ and the shared memory 130. This gives access to a large memory to each of the processors 110, 120₁ to 120ₙ as well as ability to partition the memory 130 so as to be used independently if desired. Furthermore, as shown, symmetric multiprocessor 110 ( also referred as main processor) can control each of the other 120₁ to 120ₙ processors through a control path. It may also be appreciated that instead of the control path, some portion of the shared memory 130 can be used to pass messages and information between the processors 120₁ to 120ₙ, using appropriate mechanisms like semaphore and mutex, besides polling-based queries.

As discussed previously, such a symmetric multiple processor architecture is advantageously used in a video decoding scenario in accordance with the principles of the present invention. Typically, a coded video sequence consists of a number of coded pictures. Each picture constitutes slices which constitutes of a group of macroblocks which in turn are the smallest units into which a picture is segmented for coding. Further, each row of macroblocks of the frames constitute of 16 lines of luma data and 8 lines of chroma data. It may be noted that in case of video coded as per the Mpeg4 AVC standard, a slice may be partitioned into separate NAL units as described above.

Conventional method to achieve high-complexity video decoding is to feed separate slices of the picture to different processing units, based on the load of the processing units, since slices are independently decodable. Finally, once all the slices have been decoded, a picture is constructed consisting of the individual decoded slices. However, there are certain disadvantages associated with this approach. For example, in a case where a picture consist of just one slice, the other processing units would starve while the main processor would try to decode all of the macroblocks (group of pixel blocks in a picture) in the slice and in this case the picture. This would severely impact the performance of the overall decoding since only one of the processing units is used. Consequently, the computing power of the other processing units is wasted. Typically, only one picture can be decoded at a time, so the other processing units will never be used.

The other drawback is that the modern video coding techniques use in-loop deblocking to improve the quality of the video as well as to achieve higher compression. It may be appreciated that in-loop deblocking is performed to smooth pixels that are adjoining a block boundary in a picture. This means that the slices are not completely independent,since, deblocking can be done across slice boundaries. Owing to this dependency, existing methods will work efficiently till the reconstruction (and this only when the picture has been divided into multiple slices) and less efficiently thereafter, though technically decoding of the AVC picture is not over until the entire frame has been deblocked.

To overcome the above-mentioned drawbacks, methods and systems are disclosed that enables partial decoding of compressed video at the slice level and full decoding of the compressed video to be performed at the frame level by different processors of the symmetric multiprocessor system 100. In addition, methods and systems disclose approaches to address a problem of dependency, during deblocking, whereby a lower row of macroblocks can be deblocked only if the immediate previous row of macroblocks has been reconstructed and is available for deblocking. This arises on account of in-loop deblocking performed by modern video coding techniques as discussed above.

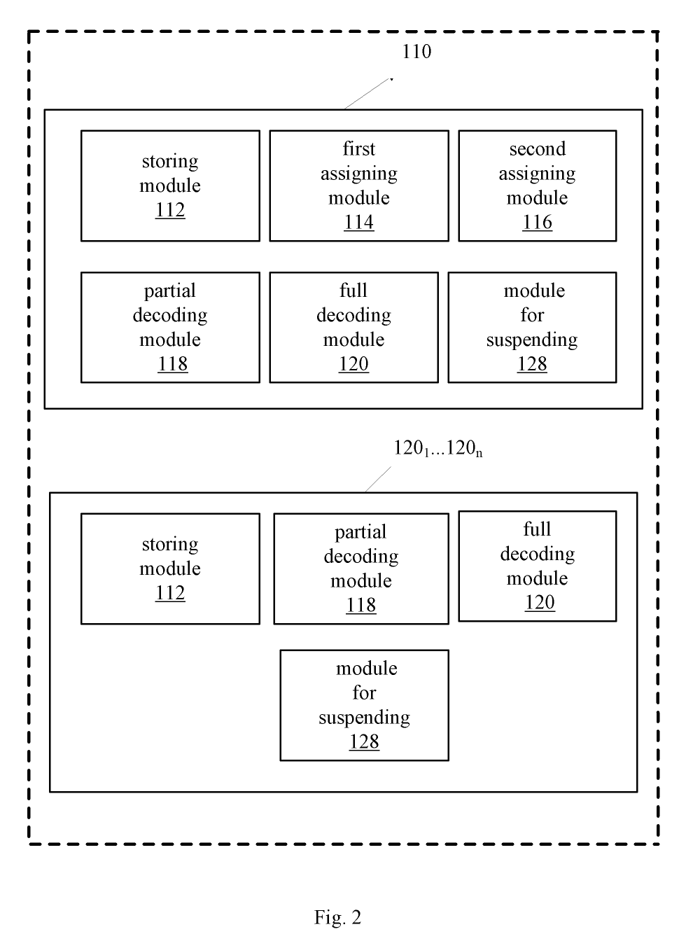

FIG. 2 schematically illustrates an exemplary exploded view of symmetric multiprocessors of FIG. 1 in further detail. As discussed previously in the context of FIG. 1, in an implementation, the system 100 constitutes a group of symmetric multiprocessors 110, 120₁ to 120ₙ (also referred as processor) coupled to a shared memory 130. In this implementation, symmetric multiprocessor 110 is configured as the main processor for performing the functions of controlling the operations of the remaining processors 120₁ to 120ₙ through the control path (as illustrated in FIG. 1) and communicating with each other (110, 120₁ to 120ₙ) and the shared memory 130 ( also referred as memory 130 hereinafter) through the data path (as illustrated in FIG. 1).

As shown in FIG. 2, in an implementation, the processors 110, 120₁ to 120ₙ includes a storing module 112. The storing module 112 is configured to store a compressed video data into the memory 130. In particular, in an implementation, the compressed video data is read and stored by the storing module 112 in the memory 130 for further processing and decoding by the system 100. As discussed previously, the system 100 may be implemented in devices embodying video applications functionality, such as handheld devices. The handheld devices are capable of playback of compressed video data. The system 100 may also be implemented as a separate kit to be used in association with such handheld devices. Typically, the compressed video data may be streaming video or video information stored in storage disks such as compact disk, digital video disk etc. As discussed previously, video data includes pictures, which in turn constitutes of slices

In an implementation, the main processor 110 includes a first assigning module 114. The first assigning module 114 is configured to assign one or more slices of a picture to one or more of the group of symmetric multiple processors 110, 120₁ to 120ₙ. Subsequently, a partial decoding module 118 in the processors 110, 120₁ to 120ₙ is configured to partially decode the one or more slices. In particular, in an example, partial decoding implies performing only an initial stage of decoding, say, for example, variable length decoding. Through, variable length decoding, the compressed video data can be parsed to obtain, for example, motion data and/or error data. Thus, at this stage, the picture is not reconstructed and deblocked and hence not fully decoded. In a successive progression, the partially decoded one or more slices are written into the memory 130. Thus, the memory 130 contains the picture with partially decoded slices.

In a further implementation, the main processor 110 includes a second assigning module 116. The second assigning module 116 is configured to assign a row of macroblocks of the frames to each of the processors 110, 120₁ to 120ₙ for performing full decoding. Accordingly, each of the processors 110, 120₁ to 120ₙ constitute a full decoding module 120 to perform full decoding of the picture. In an example, full decoding implies performing motion compensation, reconstruction, and deblocking of the coded sequence.

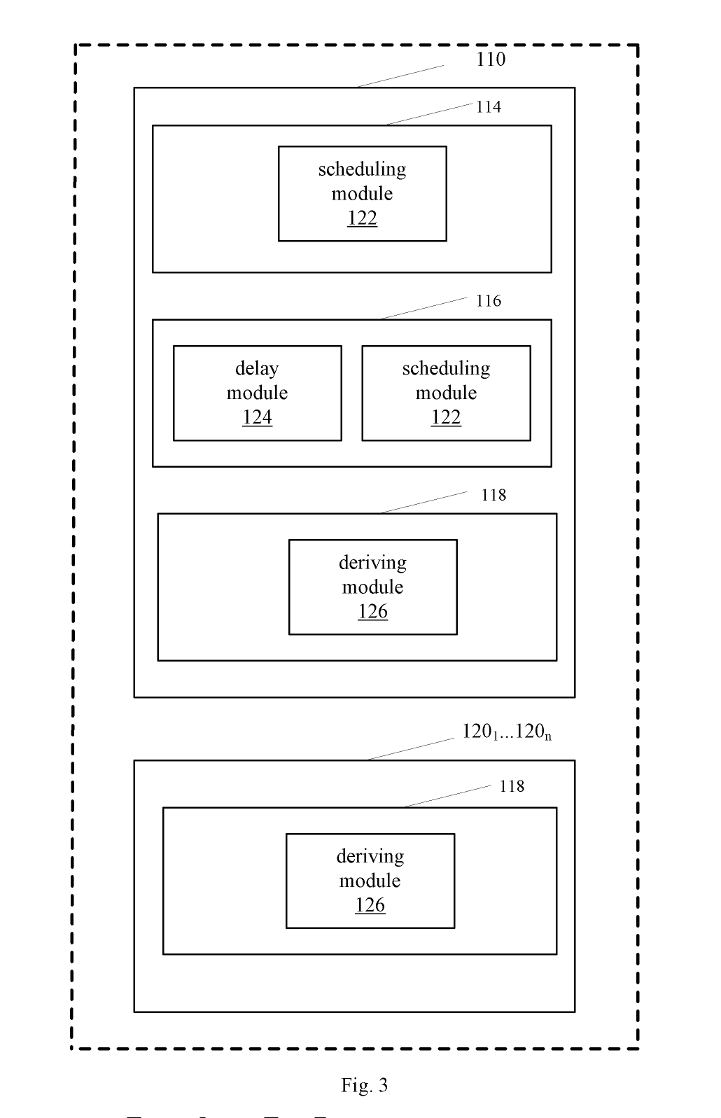

FIG. 3 further depicts an exemplary exploded view of the symmetric multiprocessors of FIG. 2. As discussed above, at the partial decoding stage, motion data and/or error data is derived. In an implementation, the partial decoding module 118 in the processors 110, 120₁ to 120ₙ may include a deriving module 126. The deriving module 126 is configured to derive information, from the compressed video data, indicative of motion data and error data. In a further implementation, the motion data may include motion vector that represents a macroblock in the picture based on the position of the macroblock. In a still further implementation, the first assigning module 114 in the main processor 110 includes a scheduling module 122. In a still further implementation, the second assigning module 116 in the main processor 110 includes a scheduling module 122. As discussed previously, one or more slices are allotted to the processors 110, 120₁ to 120ₙ for partial decoding of the slices. In this implementation, the scheduling module 122 is configured to schedule the partial decoding of the one or more slices based on the comparable workload of the processors 110, 120₁ to 120_{n.} In yet another implementation, the scheduling module 122 is configured to schedule the full decoding of the one or more slices based on the comparable workload of the processors 110, 120₁ to 120_{n.} Thus, the multiple processors 110, 120₁ to 120_{n,} in combination, advantageously perform decoding of the picture containing at least one slice.

In contrast to the existing systems and methods, the division of processing load among the processors 110, 120₁ to 120ₙ is dependent only on the number of rows of macroblocks in each frame and not on the number of slices. Moreover, in this approach of decoding multiple rows of macroblocks by the processors 110, 120₁ to 120ₙ, load balancing is at a finer granularity. This is so, since, as discussed previously, the division of processing load is not dependent on the number of macroblocks in each slice. Rather, it is a predictable number, which, in an implementation is derived from the number of columns of macroblocks or the number of macroblocks in a row in the picture. Thus, in an implementation, the full decoding module 120 performs decoding of one or more rows of macroblocks in each of the frames. This is advantageous, since the division of processing load based on the number of macroblocks in each slice is highly variable in comparison to the division of processing load based on the number of macroblocks in each row of macroblocks.

Further, a deblocking filter is, typically, used in a decoder environment in the system 100 to perform deblocking for obtaining a good quality decoded video. In such an environment, for efficient performance, the main processor 110 must take into account the dependency as posed by the deblocking filter. For example, it may be appreciated that deblocked output from a lower row of macroblocks in a picture modifies immediate above row of macroblocks. As such, processing of the lower row of macroblocks can be started once the data of the immediate prior row of macroblocks have been motion compensated and reconstructed and are available for deblocking. This introduces delay in processing of the macroblocks and reduces the efficiency of the decoding process.

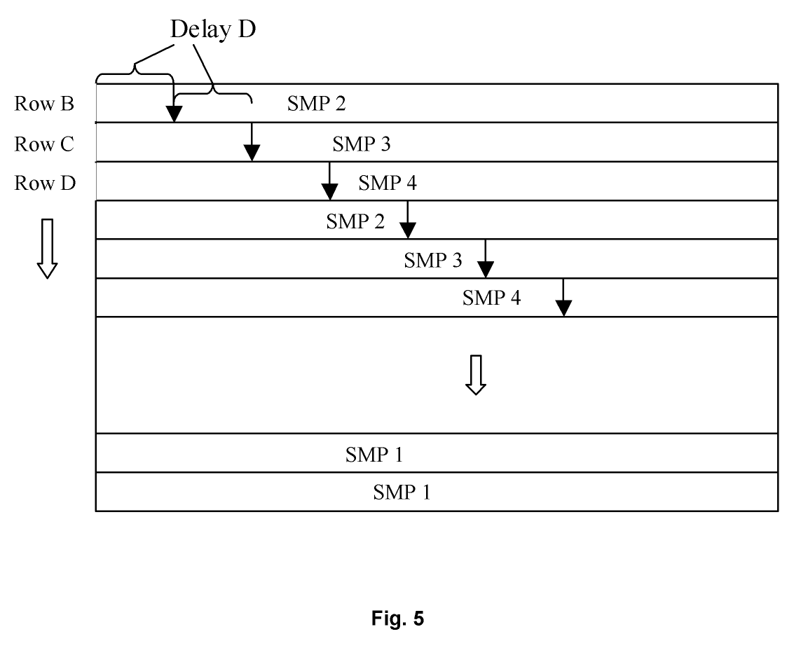

In an implementation, this dependency of the deblocking filter is removed by introducing a delay in the processing of the macroblock right below it. Referring to FIG. 5, a diagram illustrating delay procedure employed by the main processor 110 in the processing of macroblocks is shown. The processors 120₁ to 120ₙ are represented as SMP 1 to 4 in the FIG. 5. It will be understood that the processors 110, 120₁ to 120ₙ are in a parallel arrangement. As shown in example FIG. 5, the instance when row B representing lower row macroblocks is being fed to say processor 120₂ is delayed from the instance when row A representing an immediate prior row of macroblock was fed to the processor 120₁. Similarly, row C is fed to processor 120₃ with a similar delay. In this example, if the delay is represented by D, then D can correspond to roughly the amount of time required for motion compensation+reconstruction+deblocking.

Accordingly, as shown in FIG. 3, a delay module 124 is configured in the main processor 110. The delay module 124 is configured to introduce, in each frame, a delay in assigning a lower row of macroblocks to the processors 110, 120₁ to 120ₙ as compared to assigning an immediate prior row of macroblocks, in each of the frames, to the processors 110, 120₁ to 120_{n.} In an implementation, it has been experimentally found that the delay can be a predetermined delay−equal to the time required for motion compensation+reconstruction+deblocking of around 3-4 macroblocks. Additionally, in this implementation, the partial decoding module 118 is configured to calculate filter strengths associated with the deblocking filter that is required for the deblocking to be performed during full decoding. In particular, in an example embodiment, the partial decoding module 118 includes a deriving module 126 that is configured to derive the filter strengths. In this embodiment, the deriving module 126 is configured to derive information, from the compressed video data, indicative of filter strengths. Further, the calculated filter strengths are stored in the memory 130 using the storing module 112. Thus, in this implementation, the memory 130 contains the picture with partially decoded slices and the calculated filter strengths.

Alternatively, in yet another implementation, the processors 110, 120₁ to 120ₙ include a module for suspending 128. In this implementation, during deblocking of the upper row of macroblocks, the module for suspending 128 is configured to put the deblocking of, for example, last 4 lines of this row of macroblocks in abeyance. These 4 lines can be deblocked along with an immediate lower row of macroblocks. It may be noted that during such deblocking, last 4 lines of the lower row of macroblocks is put in abeyance. Thus, last 4 lines of the picture are deblocked at the end of processing of the remaining portion of the picture. It has been found that in such cases the aforementioned delay can be effectively avoided.

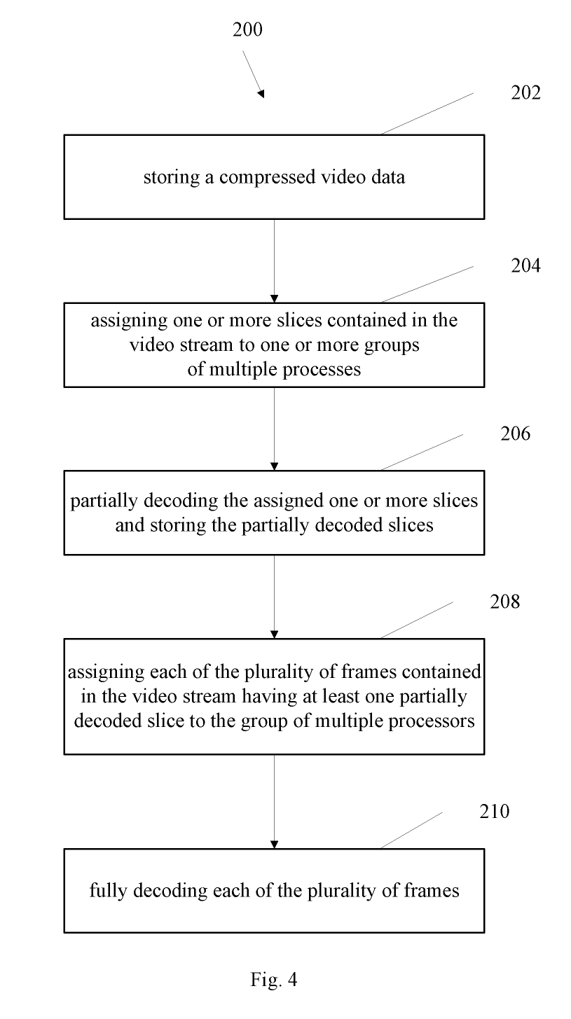

FIG. 4 shows a process that illustrates a method for decoding compressed video according to an implementation. Description of the process 200 is with reference to FIGS. 1-3 described previously. At step 202, compressed video data is stored. In particular, in an implementation, the compressed video data is stored in the shared memory 130 of the system 100. Typically, a coded video sequence consists of a number of coded pictures or frames. Each picture consititutes slices (group of macroblocks which are the basic units into which a picture is segmented for coding). It may be noted that in case of video coded as per the Mpeg4 AVC standards, a slice may be partitioned into separate NAL units as described above. It will be understood that the video data may include a streaming video data or the video data may be in the form of data stored in compact disks, digital video disks or any other storage medium.

At step 204, the one or more slices are assigned for partial decoding. In particular, in an implementation, the main processor 110 assigns the one or more slices to the processors 110, 120₁ to 120ₙ sharing the memory 130. In a further implementation, the main processor 110 assigns based on a comparable workload determination amongst each of the multiple processors 110, 120₁ to 120_{n.} As referred in FIG. 2, the first assigning module 114 performs the task of assigning the one or more slices.

At step 206, the one or more assigned slices are partially decoded. In particular, in an implementation, the one or more of the group of multiple processors 110, 120₁ to 120ₙ performs partial decoding. As implied in FIG. 2, partial decoding module 118 performs the partial decoding and stores the partially decoded one or more slices in the shared memory 130. Thus, the shared memory 130 is updated with frames that contain at least one partially decoded slice. In an implementation, partial decoding includes deriving information that represents motion data associated with the compressed video. For example, motion data may include motion vector. In yet another implementation, partial decoding may include deriving information indicative of error data associated with the compressed video. In yet another implementation, partial decoding includes deriving deblocking filter strengths. As discussed in FIG. 3, the deriving module 126 performs the deriving function stated above.

Thus, in this implementation, partial decoding implies decoding until the initial stage using variable length decoding. It may be noted that the proposed approach does not go for a full decode of the slices. Instead, each of the processors 110, 120₁ to 120ₙ decodes the slices to derive the motion data as well as the error data (achieved, for example, through variable length decoding) and writes these to the memory 130. In yet another implementation, each of the processors 110, 120₁ to 120ₙ decodes the slices to obtain the deblocking filter strengths and writes these to the memory 130. At this stage, the processors 110, 120₁ to 120ₙ do not undertake the major components of decoding, namely, motion compensation, reconstruction and deblocking. It will be understood by a person of skill in the art that these are the major components of decoding and constitutes as much as 70% of the entire load or more. Thus, the parallel processing that can be achieved by encoding a picture into different slices (which are designed to be independently decodable,) is utilized to the full by decoding the slices partially on different processors 110, 120₁ to 120ₙ.

At step 208, one or more rows of macroblocks of each of the plurality of frames having at least one partially decoded slice are assigned. In particular, in an implementation, the main processor 110 assigns one or more rows of macroblocks of each of the frames that contain at least one partially decoded slice to one or more of the group of multiple processors 110, 120₁ to 120ₙ. Referring to FIG. 2, the second assigning module 116 is configured to perform the assigning. In an implementation, the assigning is based on a comparable workload determination of the processors 110, 120₁ to 120ₙ.

At step 210, the frames are fully decoded. In particular, the frames that contain at least one partially decoded slice are fully decoded by the processors 110, 120₁ to 120ₙ in combination. In an implementation, the full decoding module 120 performs the full decoding. As discussed previously, since at the stage of partial decoding, the entire frame error data and/or the motion vectors have been made available, the entire frame is processed at this step 210, using all the available processors 110, 120₁ to 120ₙ.

In another implementation, once the partial decode is complete, the main processor 110 schedules for full decode of the frame by each of the processors 110, 120₁ to 120_{n.} The scheduling may be based on a determination of a comparable workload amongst each of the multiple processors 110, 120₁ to 120_{n.} It may be noted that the processor loading for full decoding is dependent on the number of macroblocks in each row of macroblocks. This is so, as in one implementation, the full decoding involves decoding of one or more rows of macroblocks in each of the frames.

In yet another implementation, full decoding may involve decoding of one or more columns of macroblocks in each of the frames.

Thus, in accordance with the proposed approach, full decoding takes place at geometric sections other than the slice section. As such, load sharing according to the proposed approach occurs at a finer granularity since these geometric sections have a predictable number of macroblocks. This is in contrast to the current technologies providing slice based decoding, where balancing of loads on different multiprocessor units effectively cannot take place. This is so, as the granularity of such load sharing is directly proportional to the number of macroblocks in each slice. This is where the combined strength of all the processors 110, 120₁ to 120_{n,} in the present approach will be apparent even if the picture consists of a single slice, since this division of processing load is dependent only on the number of rows or columns in each frame and not on the number of slices. Thus, even if a frame constitutes a single slice (which in spite of the encoding might be broken into different geometric segments for full decoding), the frame can be processed on separate multiprocessor units 110, 120₁ to 120_{n.}

Additionally, the current technologies do not address cases where slices in video data need to be deblocked (for better quality as in Mpeg4 Advanced Video Coding). For this reason, these technologies are not able to decode such data (encoded with Advanced Video Coding) with maximum efficiency since they are designed to cater to the previous coding standards where in-loop deblocking was not considered. Also, modern video coding standards like AVC puts in certain restrictions in the way the deblocking needs to be done. For example, the AVC standard provides for deblocking once the entire picture has been reconstructed. This restricts usage of the current technologies for parallelism, which will reduce performance. In contrast, the proposed approach avoids this reduction in scope for parallelism and enables deblocking and reconstruction to continue on different geometric segments. Also, since multiple processors are available, the decoding can be efficiently performed on different geometric segments by different processors. The current technologies do not address cases where slices need to be deblocked (for better quality as in Advanced Video Coding). For this reason, these technologies will not be able to decode such streams with maximum efficiency and power saving.

Thus, the step 210 of full decoding includes deblocking. In particular, the proposed approach is based on the fact that deblocking of a row of macroblocks (as defined in, for example, Advanced Video Coding standard) can access and modify data from the upper row of macroblocks. However, since multi-processor architecture is used, this modification can be done after the upper row of macroblocks have been processed on a different multiprocessor unit. Hence, a small delay introduced between the processing of multiple rows of macroblocks facilitates putting sufficient time difference for achieving deblocking as discussed hereinabove.

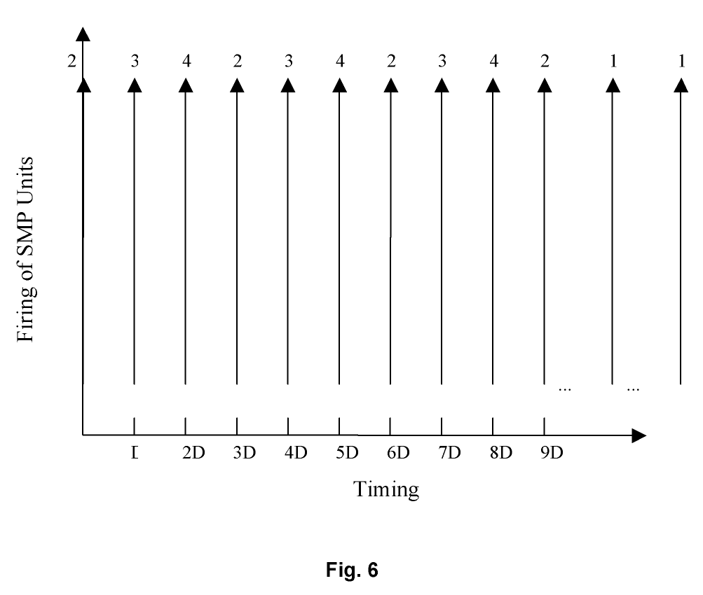

As also discussed in FIG. 6, for the purpose of simplicity, it is assumed that there are 4 processor Units 120₁ to 120₄ (illustrated as SMP unit in FIG. 6) available including the main processor 110. It will be understood that the process is similar for any other number of SMP processors as well. In FIG. 6, each of the SMP units are referred as 1, 2, 3 and 4 with 1 as the main SMP (i.e. main processor 110).

It will be understood that a deblocking filter associated with the system 100 in a decoder performs the deblocking. In accordance with the present approach, the SMP 1 decodes specific regions on specific processor 2, 3, 4 taking into account the dependency as posed by a deblocking filter as discussed hereinbefore.

In an implementation, the method includes the step of introducing a predetermined delay. In particular, the main processor 110 introduces a predetermined delay in assigning a lower row of macroblocks in each of the frames to the processors 110, in relation to assigning an immediate prior row of macroblocks in each of the frames for full decoding, to one of the multiple processors 110, 120₁ to 120_{n.}

In particular, it may be understood that deblocked output from the lower row of macroblocks modifies up to, for example, last 3 lines of the upper row of macroblocks. Meaning thereby, these rows need to have been motion compensated and reconstructed a priori when the lower row of macroblocks is processed. Thus, referring to FIG. 6, there is a hard dependency to start row B processing only after row A processing is complete. This dependency of the deblocking filter is removed by introducing a delay in the processing of the macroblock right below it. Thus, the instance when row B is being fed to SMP Unit 3 is delayed from the instance when row A was fed to the SMP Unit 2. In this manner, when processing of row B starts, the bottom 3 lines of first few macroblocks of the upper row of macroblocks have been reconstructed and are ready for processing. Similarly, row C is fed to SMP Unit 4 with a similar delay. In an implementation, it has been experimentally found that the delay can be a predetermined delay D of roughly the amount of time required for motion compensation+reconstruction+deblocking of around 3-4 macroblocks.

FIG. 6 show the graph of the firing sequence for each of the processors 120₁ to 120₄ by the main processor 110. It will be understood that the main processor 110 too can also take up processing of some rows once its main task that of allocation of all the rows to other processors 120₁ to 120ₙ is complete. This brings in maximum utilization of computing resources and an element of load balancing in the system 100.

Alternatively in yet another implementation, during deblocking of the upper row of macroblocks, the deblocking of, for example, last 4 lines of this row of macroblocks is put in abeyance. These 4 lines can be deblocked along with an immediate lower row of macroblocks. It may be noted that during such deblocking, last 4 lines of the lower row of macroblocks is put in abeyance. Thus, last 4 lines of the picture are deblocked at the end of processing of the remaining portion of the picture. It has been found that in such cases the aforementioned delay can be effectively avoided.

It will be appreciated that the teachings of the present invention can be implemented by hardware, executable modules stored on a computer-readable medium or a combination of both. The executable modules may be implemented as an application program comprising a set of program instructions tangibly embodied in a computer readable medium. The application program is capable of being read and executed by hardware such as a computer or processor of suitable architecture.

Similarly, it will be appreciated by those skilled in the art that any examples, process flows, functional block diagrams and the like represent various exemplary functions, which may be substantially embodied in a computer readable medium executable by a computer or processor, whether or not such computer or processor is explicitly shown. The processor can be a digital signal processor (DSP) or any other processor used conventionally capable of executing the application program or data stored on the computer-readable medium.

The example computer-readable medium can be, but is not limited to, random access memory (RAM), read only memory (ROM), compact disk (CD), or any magnetic or optical storage disk capable of carrying application program executable by a machine of suitable architecture. It is to be appreciated that computer readable media also includes any form of wired or wireless transmission. Further, in another implementation, the method in accordance with the present invention can be incorporated on a hardware medium using ASIC or FPGA technologies.

Advantageously, the present approach performs full decoding on different geometric segments by different processors 110, 120₁ to 120ₙ of the symmetric multiprocessor system 100. This enables to avoid the reduction in the scope for parallelism, which enables deblocking and reconstruction to continue on different geometric segments. In addition, since, in this approach different geometric segments are being processed by the different multiprocessor units 110, 120₁ to 120ₙ, it is a more robust maximization of resources. Further, the present approach also optimizes the single slice case.

The key point here is that the decoding as per the present approach moves to the use of different geometric division than that performed by an encoder during coding process. Whereas, the encoder encodes slices independently (primarily for parallel decoding purposes) the decoding as per the present approach uses this fact until the maximum achievable efficiency for decoding independent slices is reached. However, beyond that the decoding approach draws a line and switches to a more robust method of maximization of resources (in this case processor time), which also enhances the efficiency.

Besides, some of the current technologies when applied on modern video coding standards may result in higher power requirements. The proposed approach on multiprocessor architecture 100 provides a simple scalable and power-saving solution.

It is to be appreciated that the subject matter of the claims are not limited to the various examples an language used to recite the principle of the invention, and variants can be contemplated for implementing the claims without deviating from the scope. Rather, the embodiments of the invention encompass both structural and functional equivalents thereof.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

We claim:

1. A method for decoding compressed video data, the method comprising:
storing the compressed video data in a memory, the video having a plurality of frames, each of the plurality of frames having one or more slices;
assigning the one or more slices, by a main processor of a group of symmetric multiple processors sharing the memory, to the group of multiple processors;
partially decoding the one or more assigned slices by the one or more of the group of multiple processors and storing the partially decoded one or more slices in the memory;
assigning, by the main processor, each of the plurality of frames having at least one partially decoded slice to one or more of the group of multiple processors; and
fully decoding each of the plurality of frames by the group of multiple processors in combination.

2. The method of claim 1, wherein the step of partially decoding includes deriving information indicative of motion data associated with the compressed video.

3. The method of claim 2, wherein the motion data comprises motion vector.

4. The method of claim 1, wherein the step of partially decoding includes deriving information indicative of error data associated with the compressed video.

5. The method of claim 1, wherein the step of partially decoding further includes calculating filter strengths for performing deblocking and storing the calculated filter strengths in the memory.

6. The method of claim 1, wherein the steps of assigning includes assigning of a comparable workload amongst each of the multiple processors.

7. The method of claim 1, wherein the step of assigning each of the plurality of frames includes scheduling the full decoding of each of the plurality of frames by the multiple processors in combination.

8. The method of claim 7, wherein the scheduling comprises assigning of a comparable workload amongst each of the multiple processors.

9. The method of claim 1, wherein the step of fully decoding includes decoding one or more rows of macroblocks in each of the frames.

10. The method of claim 1, wherein the step of fully decoding includes decoding one or more columns of macroblocks in each of the frames.

11. The method of claim 1, wherein the step of full decoding includes deblocking each of the plurality of frames.

12. The method of claim 1, wherein the method further includes the step of introducing a predetermined delay, by the main processor, in assigning a lower row of macroblocks in each of the frames for full decoding, in relation to assigning an immediate prior row of macroblocks, in each of the frames for full decoding, to one of the multiple processors in a parallel arrangement of the multiple processors.

13. The method of claim 12, wherein the predetermined delay corresponds to, approximately, time required for one or more of: motion compensation, reconstruction and deblocking of 3 to 4 macroblocks in each of the frames.

14. The method of claim 1, wherein the method further comprises step of temporarily suspending deblocking of at least last 4 lines of upper row of macroblocks and resuming the deblocking of the at least last 4 lines alongwith deblocking of an immediate lower rows of macroblocks.

15. A system for decoding compressed video, the system comprising:
a group of symmetric multiple processors;
a memory coupled to the group of symmetric multiple processors;
a storing module, in each of the group of symmetric multiple processors, configured to store a compressed video data into the memory, the video having a plurality of frames, each frame having one or more slices;
a first assigning module, in the main processor, configured to assign one or more slices to one or more of the group of symmetric multiple processors for partial decoding;
a partial decoding module, in each of the symmetric multiple processors, configured to partially decode the one or more assigned slices and storing the partially decoded one or more slices in the memory;
a second assigning module, in the main processor, configured to assign each of the plurality of frames having at least one partially decoded slice for full decoding to the group of multiple processors; and
a full decoding module, in each of the symmetric multiple processors, configured to fully decode each of the plurality of frames in combination.

16. The system of claim 15, wherein the partial decoding module includes a deriving module configured to derive information indicative of motion data and error data associated with the compressed video.

17. The system of claim 16, wherein the motion data includes motion vector.

18. The system of claim 15, wherein the partial decoding module includes a deriving module configured to derive deblocking filter strengths from the compressed video data.

19. The system of claim 15, wherein the first assigning module includes a scheduling module configured to schedule the full decoding of each of the plurality of frames performed by the multiple processors in combination.

20. The system of claim 15, wherein the second assigning module includes a scheduling module configured to schedule the full decoding of each of the plurality of frames performed by the multiple processors in combination.

21. The system of claim 15, wherein the full decoding module performs decoding of at least one of: one or more rows of macroblocks and one or more columns of macroblocks in each of the frames.

22. The system of claim 15, further comprising:
a delay module, in the main processor, configured to introduce a predetermined delay in assigning a lower row of macroblocks, in each of the frames, in relation to assigning an immediate prior row of macroblocks, in each of the frames, to one of the group of symmetric multiple processors in a parallel arrangement of the multiple processors.

23. The system of claim 22, wherein the second assigning module includes the delay module.

24. The system of claim 22, wherein the predetermined delay corresponds to, approximately, the time required for one or more of: motion compensation, reconstruction and deblocking of 3 to 4 macroblocks in at least one frame.

25. The system of claim 15, wherein the group of multiprocessors additionally include a module for suspending configured to temporarily suspend deblocking of at least last 4 lines of upper row of macroblocks and resuming the deblocking of the at least last 4 lines along with deblocking of an immediate lower row of macroblocks.

26. A computer-readable medium tangibly embodying a set of computer executable instructions for decoding compressed video data, the computer executable instructions comprising modules for:
storing the compressed video data in a memory, the video having a plurality of frames, each frame having one or more slices;
assigning the one or more slices, by a main processor of a group of symmetric multiple processors sharing the memory, to the group of multiple processors;
partially decoding the one or more assigned slices by the one or more of the group of multiple processors and storing the partially decoded one or more slices in the memory;
assigning, by the main processor, each of the plurality of frames having at least one partially decoded slice to one or more of the group of multiple processors; and
fully decoding each of the plurality of frames by the group of multiple processors in combination.

27. The computer-readable medium of claim 26, wherein the module for partially decoding includes a module for deriving information indicative of motion data associated with the compressed video.

28. The computer-readable medium of claim 27, wherein the motion data comprises motion vector.

29. The computer-readable medium of claim 26, wherein the module for partially decoding includes a module for deriving information indicative of error data associated with the compressed video.

30. The computer-readable medium of claim 26, wherein the module for partially decoding includes a module for writing into the memory the partially decoded slices.

31. The computer-readable medium of claim 26, wherein the module for partially decoding further includes a module for calculating filter strengths for performing deblocking and storing the calculated filter strengths in the memory.

32. The computer-readable medium of claim 26, wherein the module(s) for assigning includes assigning of a comparable workload amongst the multiple processors.

33. The computer-readable medium of claim 26, wherein the module for assigning each of the plurality of frames includes a module for scheduling the full decoding of each of the plurality of frames by the multiple processors in combination.

34. The computer-readable medium of claim 33, wherein the module for scheduling includes module for allotting a comparable workload amongst the multiple processors.

35. The computer-readable medium of claim 26, wherein the module for fully decoding includes a module for decoding one or more rows of macroblocks in each of the frames.

36. The computer-readable medium of claim 26, wherein the module for fully decoding includes a module for decoding one or more columns of macroblocks in each of the frames.

37. The computer-readable medium of claim 26, wherein the module for full decoding includes a module for fully deblocking each of the frames.

38. The computer-readable medium of claim 26, wherein the computer executable instructions further includes a module for introducing a predetermined delay, by the main processor, in assigning a lower row of macroblocks, in each of the frames, in relation to assigning an immediate prior row of macroblocks, in each of the frames, to one of the multiple processors in a parallel arrangement of the multiple processors.

39. The computer-readable medium of claim 38, wherein the predetermined delay corresponds to, approximately, the time required for one or more of: motion compensation, reconstruction and deblocking of 3 to 4 macroblocks in a frame.

40. The computer readable medium of claim 26, wherein the computer executable instructions further includes a module for temporarily suspending deblocking of at least last 4 lines of upper row of macroblocks and resuming the deblocking of the at least last 4 lines along with deblocking of an immediate lower row of macroblocks.

41. The computer-readable medium of claim 26, wherein the video data is encoded in MPEG standards.
